(19) United States
(12) Patent Application Publication
(10) Pub. No.: US 2009/0019782 A1
(43) Pub. Date: Jan. 22, 2009

(54) ABRASIVE TOOL HAVING SPRAY-FORMED BRAZING FILLER LAYER AND MANUFACTURING PROCESS THEREOF

(75) Inventors: Yu-Tai Chen, Yingge Township (TW); Chou-Chih Tseng, Yingge Township (TW); Hsiu-Yi Lin, Rueifang Township (TW)

Correspondence Address: RABIN & Berdo, PC, 1101 14TH STREET, NW, SUITE 500, WASHINGTON, DC, 20005, US

(73) Assignee: KINIK COMPANY, Taipei (TW)

(21) Appl. No.: 12/172,417

(22) Filed: Jul. 14, 2008

(30) Foreign Application Priority Data
Jul. 18, 2007 (TW) 096126228

(51) Int. Cl. C09K 3/14; C08J 5/14

(52) U.S. Cl. 51/309

(57) ABSTRACT

An abrasive tool having a spray-formed brazing filler layer and a manufacturing process thereof are described, in which drawing and adhering steps performed on a conventional brazing filler layer are simplified through spraying. A solvent, an adhesive, and a powder are sequentially mixed to form a brazing filler slurry; next, the brazing filler is sprayed on a substrate, so as to form a brazing filler layer with an appropriate thickness; and then, abrasive particles are adhered to the brazing filler layer, and then the abrasive particles are combined with the substrate through the brazing filler layer by brazing. The conventional drawing and adhering steps are omitted through spraying, and it is applicable for substrates with complicated shapes.

### CROSS-REFERENCE TO RELATED APPLICATIONS

This non-provisional application claims priority under 35 U.S.C. §119(a) on Patent Application No(s). 096126228 filed in Taiwan, R.O.C. on Jul. 18, 2007 the entire contents of which are hereby incorporated by reference.

### BACKGROUND OF THE INVENTION

1. Field of the Invention

The present invention relates to an abrasive tool and a manufacturing process thereof, which is applicable for manufacturing abrasive tools for the stone material, glass, semiconductor, and optical industries, and more particularly to a manufacturing process of an abrasive tool having a spray-formed brazing filler layer.

2. Related Art

No matter in industrial manufacturing fields, industrial art, art and craft, or in personal house usage, abrasive tools have quite a long history, and have quite wide functions, for example, cutting, drilling, polishing, or finishing. The abrasive tool having abrasive particles fixed on a surface thereof achieves the function of grinding a work piece by using the high hardness and high abrasion resistance characteristics of the abrasive particles. Currently, diamond is one of the hardest industrial materials, so usually the diamond is used as a super-abrasive for the abrasive tool in the industry. For example, a polishing pad conditioner widely used in the chemical mechanical polishing (CMP) of the semiconductor wafer manufacturing industry is an abrasive tool with diamond as the abrasive particles. In the basic structure of the polishing pad conditioner, a plurality of diamond particles is fixed on a combination surface of the abrasive particles of a disk-type or a ring-type metal substrate (or called base metal). Therefore, the abrasive tool used to condition the polishing pad is also called a diamond disk pad conditioner (or pad dresser).

Conventionally, as for the manner of manufacturing the abrasive tool or the diamond disk, a powder and an adhesive are mulled into a deformable mixture according to an appropriate ratio (usually, it is approximately 100:3). Then, the deformable mixture is drawn into a thin sheet by a roller, and is cut into a disk-shaped brazing filler layer according to a required size. After the adhesive is sprayed on the metal substrate (or called base metal) for a first time, the brazing filler layer is adhered to the substrate. Then, the adhesive is sprayed for a second time, such that the abrasive particles are adhered. Finally, dewaxing, baking in a furnace, and brazing steps are performed, such that the abrasive particles are fixed on the substrate, so as to form an abrasive tool.

However, such manufacturing process has quite a lot of problems. The drawing process is performed by the roller, so the minimum thickness is limited (it is must be larger than 0.1 mm), which cannot meet various demands. Meanwhile, the drawing process is performed through rolling, which is limited by the shape, so it cannot meet the demand of the base metal with a special shape. Since the drawing process is performed through rolling, the generated brazing filler layer has a poor uniformity and the surface accuracy is not sufficiently high. Such a manufacturing process is not only relatively complicated and manpower-consuming, but also the adhesive is sprayed twice. Once it is heated under a high temperature, the adhesive easily turns into hydrocarbon, thereby resulting in the problems of carbon residues and sintering.

In order to solve the above problems, some different manufacturing processes have been provided in the prior art, for example, US Patent Publication No. 5,620,489, entitled “Method for Making Powder Preform and Abrasive Articles Made There from”, in which the abrasive particles are contained in a preform, and an abrasive tool is manufactured by sintering. Although the rolling step is effectively replaced, it is still quite complicated in the manufacturing process, which still needs to be improved.

### SUMMARY OF THE INVENTION

In order to solve the above problems, the present invention is directed to an abrasive tool having a spray-formed brazing filler layer and a manufacturing process thereof, applicable for solving the problems resulting from the rolling process in the conventional art, and providing a manufacturing process, which has simple steps and saves both manpower and time.

In the manufacturing process of an abrasive tool having a spray-formed brazing filler layer provided by the present invention, the brazing filler layer is mainly formed by spraying, and the rolling-drawing and adhering steps in the conventional art are omitted.

In the present invention, according to a certain ratio and feeding sequence, a powder, a solvent, and an adhesive are uniformly mixed to form a mixture slurry that can be sprayed. Next, the mixture slurry is sprayed on a substrate through an air pressure, so as to form a brazing filler layer on the substrate, in which the thickness and uniformity of the brazing filler layer are controlled by magnitude of the sprayed slurry, time, and distance of the spraying process. Then, after the abrasive particles are directly adhered, dewaxing, and brazing steps are performed. The conventional rolling-drawing process is replaced by the spraying process in the present invention, such that the present invention gets rid of the troubles brought by the rolling-drawing process, achieves a better brazing surface, and meanwhile, the present invention is applicable for base metals with various shapes. The mixture slurry used for spraying already includes an adhesive, so as to avoid the great amount of adhesive residues resulting from spraying the adhesive twice, and to prevent the great amount of adhesives from being deteriorated and sintered due to being heated subsequently.

Furthermore, if abrasive particles with ultra-small particle sizes are applied in the present invention, the abrasive particles may be mixed in the brazing filler, and then both the abrasive particles and the brazing filler are sprayed on the base metal, and then the dewaxing and brazing steps are directly performed, so as to form an abrasive tool. In addition to saving the processing steps, the present invention can further improve the uniformity of the abrasive particles and the brazed surface.

### BRIEF DESCRIPTION OF THE DRAWINGS

FIG. 1 is a schematic view of spraying a brazing filler on a substrate according to the present invention;

FIG. 2 is a schematic view of forming a brazing filler layer on the substrate according to the present invention;

FIG. 3 is a schematic view of adhering abrasive particles according to the present invention;

FIGS. 4A to 4C are schematic views of arrangements of abrasive particles according to the present invention;

FIG. 5 is a schematic view of a formed abrasive tool according to the present invention;

FIG. 6A is an outside view of combining abrasive particles with the brazing filler layer according to the present invention; and

FIG. 6B is an outside view of combining abrasive particles with the brazing filler layer according to the present invention.

### DETAILED DESCRIPTION OF THE INVENTION

An abrasive tool having a spray-formed brazing filler layer and a manufacturing process thereof provided by the present invention are suitable for solving various problems resulting from the rolling-drawing process adopted to manufacture the abrasive tool in the conventional art and avoiding the problem of the limited application scope, such that the abrasive tool of the present invention achieves a better brazing surface and powder particle size, and is applicable for base metals with various shapes. Therefore, besides being applied to manufacture abrasive tools in the stone material, glass, semiconductor, and optical industries, the method of the present invention is particularly applied to manufacture a polishing pad conditioner in a chemical mechanical polishing (CMP) with a high requirement on accuracy. Therefore, a detailed description is given below by taking a method for manufacturing the polishing pad conditioner as an embodiment.

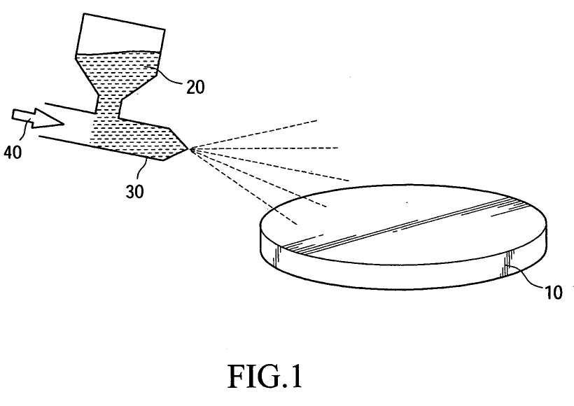

Referring to FIG. 1, first, a substrate 10 (or called a base metal) is provided, which is preferably a disk-shaped metal substrate or a polymer disk, for example, a stainless steel metal disk. Then, a brazing filler 20 is sprayed on the substrate 10, in which the brazing filler 20 is sprayed by using a spraying device 30 through an air pressure 40, and is adhered to the substrate 10. The brazing filler 20 is a mixture slurry, and is formed by mixing a metal powder, for example, an LM powder (Ni—Cr alloy powder), a solvent, for example, toluene or thinner, and an adhesive according to an appropriate ratio and a certain mixing sequence, in which the adhesive may be a resin adhesive, a normal-temperature hardened resin, and the like. For example, according to a ratio of the solvent to the adhesive as 3:2, the adhesive is dissolved in the solvent, so as to form a mixed solvent. Then, according to an appropriate ratio of the mixed solvent to the metal powder as 3:1, the metal powder is added into the mixed solvent, so as to form a slurry of the brazing filler 20. Definitely, the ratios are not limited herein, and any ratio may be adopted, so long as the ratio enables the brazing filler 20 to be sprayed by the spraying device 30 (for example, a spray gun).

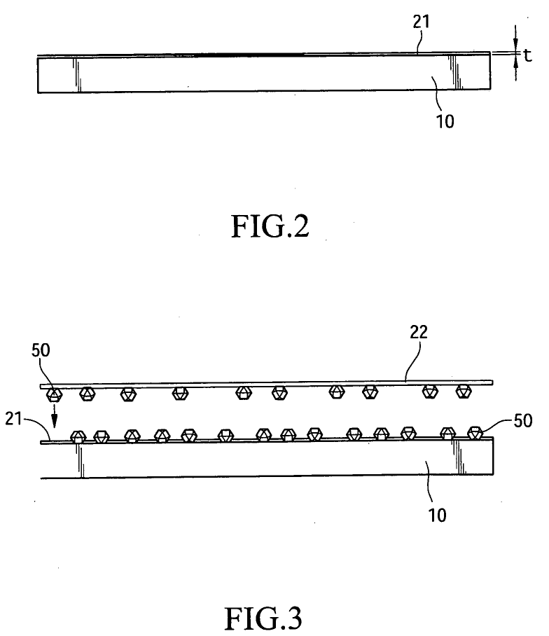

Then, the brazing filler 20 is sprayed on the substrate 10 to form a brazing filler layer 21, as shown in FIG. 2. A thickness t of the brazing filler layer 21 may be controlled by the magnitude of the sprayed slurry, distance, and time of the spraying process, and a concentration ratio of the brazing filler 20. Considering the ratio of the brazing filler 20, if it contains higher amount of metal powder, it achieves the required thickness in a shorter time during spraying, so as to save the spraying time. However, the more the metal powder is, the thicker the brazing filler 20 is, so it is not easy to spray the brazing filler 20, and thus, a higher air pressure 40 is required. On the contrary, the less the metal powder is, the thinner the brazing filler 20 is, so that it is easy to spray the brazing filler 20, and accordingly, a longer spraying time is required to achieve the required thickness. Similarly, the thickness and uniformity of the brazing filler layer 21 may be controlled by the time and distance of the spraying process. Therefore, the time of the spraying process and ratio of the sprayed slurry are not limited to any condition, which are correspondingly varied depending upon the actually demands.

Referring to FIG. 3, abrasive particles 50 are directly adhered to the brazing filler layer 21. Particularly, the abrasive particles 50 are first adhered to an adhesion layer 22 with a low viscosity (for example, an adhesive tape), and then are transferred the abrasive particles 50 to the brazing filler layer 21 with a high viscosity and regularly arranged thereon. The abrasive particles 50 may be diamond, cubic boron nitride (CBN), alumina, silicon carbide and the like, which are varied according to the work pieces to be polished. Definitely, as for the diamond disk, the diamond is taken as the abrasive particles 50, and the particle size of the adopted diamond particles is 35-150 μm. However, according to the practical operation and usage requirements, the particle size of the abrasive particles may be in a range of 10-500 μm, which is not limited to this embodiment. Since the brazing filler 20 already contains the adhesive, it can be adhered to the substrate 10 when being sprayed on the substrate 10, and what's more, after the brazing filler layer 21 has been formed, the brazing filler 20 still has certain viscosity and further enables the abrasive particles 50 to be directly adhered to the brazing filler layer 21. Compared with the rolling-drawing and adhering manner in the conventional art, the process of spraying the adhesive twice is omitted in the present invention, and the adhesive amount is reduced, so as to prevent the adhesive residue and sintering.

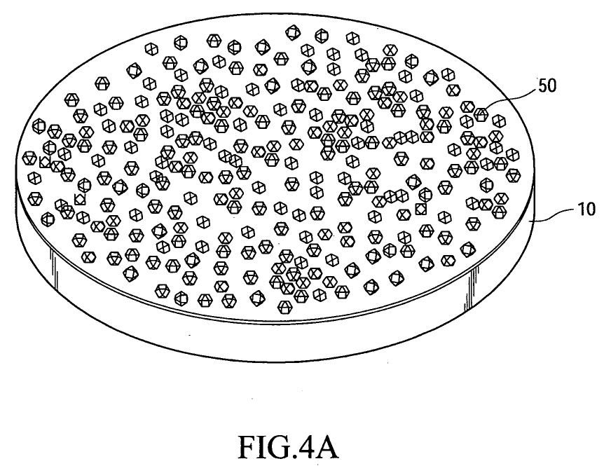

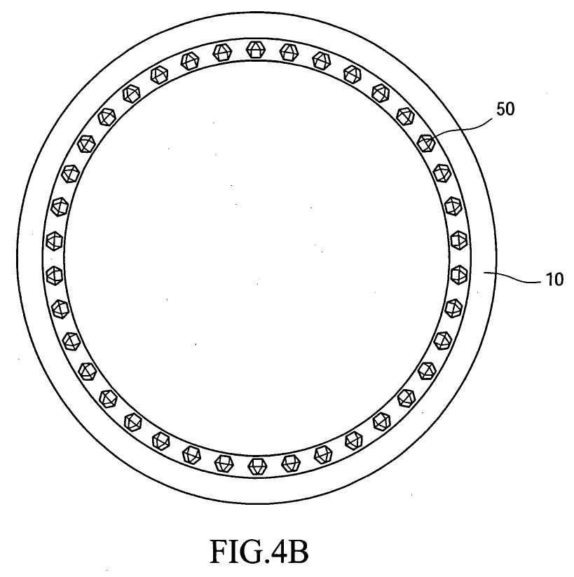

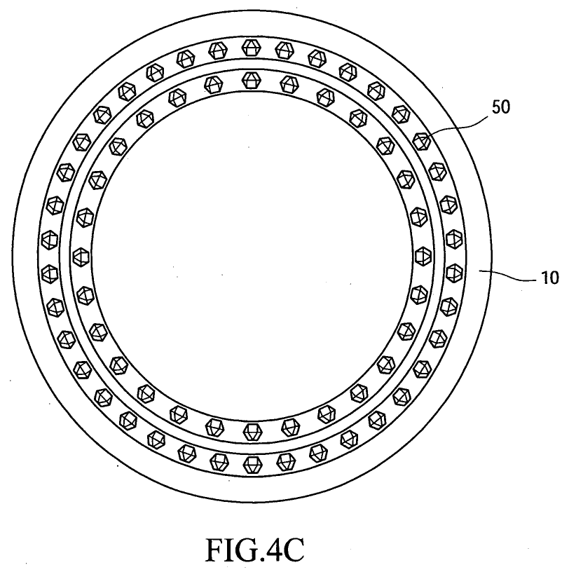

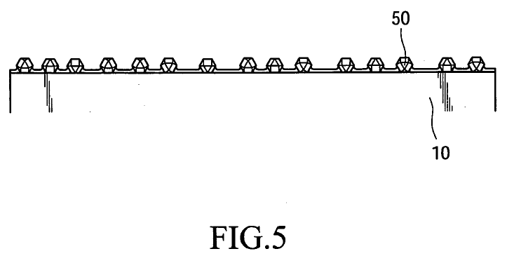

The abrasive particles 50 are adhered at random (as shown in FIG. 4A) or in sequence. The arrangement achieved through adhering in sequence may be a ring shape (as shown in FIG. 4B) or a dual-ring shape (as shown in FIG. 4C), which is mainly changed and designed according to the demands on the finished abrasive tool.

Then, dewaxing and furnace brazing processes are performed to make the brazing filler layer 21 and the abrasive particles 50 be chemically bonded, such that the abrasive particles 50 are stably combined with the substrate 10. In the dewaxing process, the brazing filler layer 21 is first heated to 200° C. and continuously heated for one to two hours, so as to remove the solvent and the adhesive of the brazing filler layer 21. Then, the furnace brazing process at a temperature of 1020° C. is performed, such that the abrasive particles 50 are combined on the substrate 10. However, depending upon the practical operation and usage requirements, a processing temperature of the furnace brazing process may be selected as 950° C. to 2000° C., which is not limited to this embodiment.

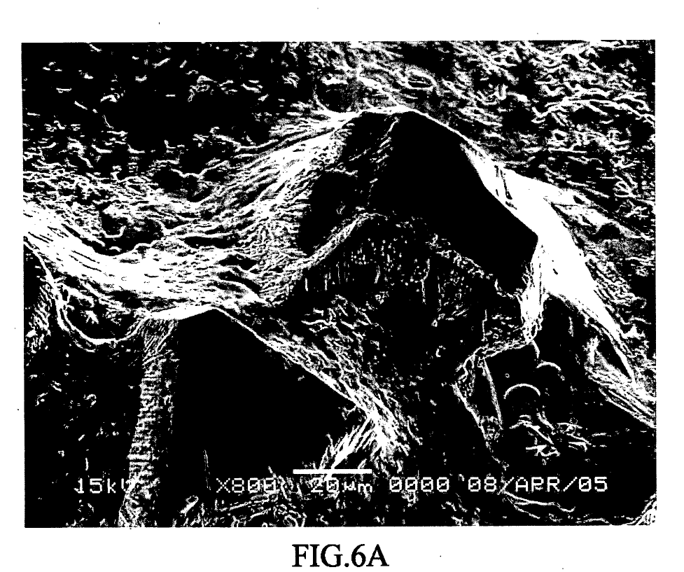

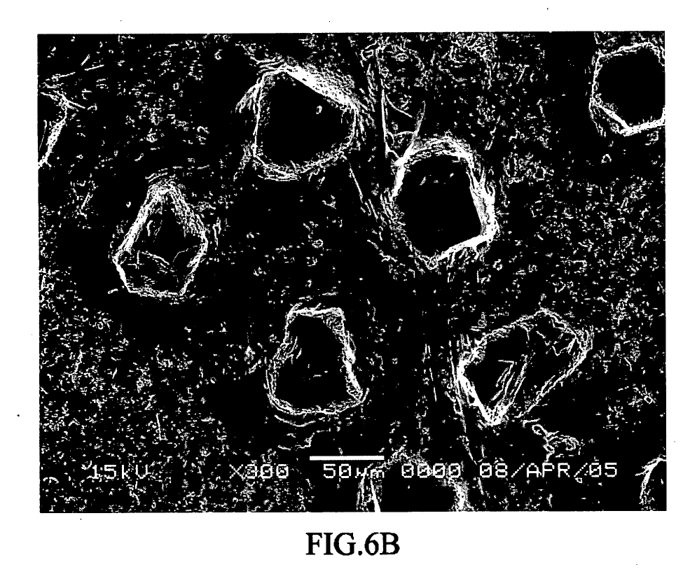

Referring to FIG. 5, finally, after the brazing process, the abrasive particles 50 are fixed on the substrate 10 through the brazing filler layer 21, so as to become a finished abrasive tool. Definitely, special processes, for example, film coating, may be performed subsequently according to actual demands. Referring to FIG. 6A (at a magnification of 800×) and FIG. 6B (at a magnification of 300×), outside views obtained through a scanning electron microscope (SEM) are shown. The spraying manner is adopted, so the present invention can be applied to the substrate 10 with various shapes, as compared with the rolling-drawing and adhering manners in the conventional art. Through adopting the spraying manner, a small amount of adhesive is sprayed on the surface, so that the present invention has the advantages of a uniform powder particle size, desirable brazing surface, and being applicable for substrates with various shapes.

On the other aspect, when the abrasive particles 50 with a smaller particle size are used, the abrasive particles 50 may be directly mixed in the brazing filler 20. Both the abrasive particles 50 and the brazing filler 20 are sprayed on the substrate 10, and then the dewaxing and brazing steps are directly performed, so that the step of adhering the abrasive particles 50 is further omitted. Definitely, as the abrasive particles 50 and the brazing filler 20 together are sprayed on the substrate 10, the thickness of the brazing filler layer 21 formed after the spraying process is limited to a certain condition, that is, the abrasive particles 50 must be exposed out of the brazing filler layer 21 after the brazing process.

The present invention provides an abrasive tool having a spray-formed brazing filler layer and a manufacturing process thereof. The brazing filler layer is formed by means of spraying, and the mulling and rolling-drawing processes in the conventional art are omitted. In the present invention, the metal powder, the adhesive, and the solvent are mixed to form the brazing filler slurry according to a certain ratio and mixing sequence. Then, the brazing filler is sprayed on the substrate through using the air pressure. Since the spraying manner is adopted, the thickness and uniformity of the brazing filler layer formed on the substrate may be controlled by the time, distance of the spraying process, and the magnitude of the sprayed slurry. Then, the diamond and other abrasive particles are adhered, and then the dewaxing and brazing processes are performed, so as to form an abrasive tool.

Through the present invention, the complicated rolling-drawing process in the conventional art is omitted, and it is not necessary to spray the adhesive on the substrate, such that only a small amount of adhesives is existed on the surface, thus effectively avoiding the adhesive residues and sintering. Meanwhile, the present invention has advantages of a uniform powder particle size, desirable brazing surface, and being applicable for substrates with complicated shapes. Meanwhile, the abrasive particles may be mixed in the brazing filler, so as to be sprayed on the substrate together, thereby saving the manufacture cost.

Although the present invention has been explained in relation to its preferred embodiment, it is to be understood that many other possible modifications and variations can be made without departing from the scope of the invention.

What is claimed is:

1. A manufacturing process of an abrasive tool having a spray-formed brazing filler layer, wherein the abrasive tool comprises a substrate and abrasive particles fixed on the substrate, the manufacturing process comprising:
providing a substrate;
spraying a brazing filler slurry on the substrate, and forming a brazing filler layer;
adhering the abrasive particles to the brazing filler layer; and
combining the abrasive particles with the substrate through the brazing filler layer by means of brazing.

2. The manufacturing process of an abrasive tool having a spray-formed brazing filler layer according to claim 1, wherein the step of adhering the abrasive particles on the brazing filler layer comprises:
arranging and adhering the abrasive particles to an adhesion layer, and transferred the adhesion layer with the abrasive particles to the brazing filler layer, such that the abrasive particles are arranged and fixed on the brazing filler layer, wherein an arrangement regularity of the abrasive particles is controlled by the adhesion layer.

3. The manufacturing process of an abrasive tool having a spray-formed brazing filler layer according to claim 1, wherein the substrate is a metal disk.

4. The manufacturing process of an abrasive tool having a spray-formed brazing filler layer according to claim 1, wherein the substrate is a polymer disk.

5. The manufacturing process of an abrasive tool having a spray-formed brazing filler layer according to claim 1, wherein the abrasive tool is a polishing pad conditioner in a chemical mechanical polishing (CMP) process.

6. The manufacturing process of an abrasive tool having a spray-formed brazing filler layer according to claim 1, wherein the brazing filler slurry contains an adhesive, a solvent, and a metal powder.

7. The manufacturing process of an abrasive tool having a spray-formed brazing filler layer according to claim 6, wherein a mixing sequence for forming the slurry brazing filler comprises adding the solvent, the adhesive, and the metal powder in sequence.

8. The manufacturing process of an abrasive tool having a spray-formed brazing filler layer according to claim 6, wherein the adhesive is a resin adhesive.

9. The manufacturing process of an abrasive tool having a spray-formed brazing filler layer according to claim 1, wherein the abrasive particles are any one selected from a group consisting of diamond, cubic boron nitride (CBN), alumina, and silicon carbide.

10. A manufacturing process of an abrasive tool having a spray-formed brazing filler layer, comprising: covering a brazing filler layer on a substrate; next, adhering abrasive particles to the brazing filler layer; and then, combining the abrasive particles on the substrate through the brazing filler layer by means of brazing, wherein the process of covering the brazing filler layer comprises:
mixing a solvent, an adhesive, and a powder according to an appropriate ratio, so as to form a brazing filler slurry; and
spraying the brazing filler slurry to a surface of the substrate.

11. The manufacturing process of an abrasive tool having a spray-formed brazing filler layer according to claim 10, wherein the abrasive tool is a polishing pad conditioner in a chemical mechanical polishing (CMP) process.

12. The manufacturing process of an abrasive tool having a spray-formed brazing filler layer according to claim 10, wherein the adhesive is a resin adhesive.

13. The manufacturing process of an abrasive tool having a spray-formed brazing filler layer according to claim 10, wherein the powder is a metal powder.

14. An abrasive tool, formed through spraying by a spraying device, comprising:
a substrate;
a brazing filler layer, covered on the substrate; and
a plurality of abrasive particles, arranged and combined with the brazing filler layer, for being fixed on the substrate.

15. The abrasive tool according to claim 14, wherein the substrate is a metal disk.

16. The abrasive tool according to claim 14, wherein the substrate is a polymer disk.

17. The abrasive tool according to claim 14, wherein the abrasive particles are any one selected from a group consisting of diamond, cubic boron nitride (CBN), alumina, and silicon carbide.
